(19) United States
(12) Patent Application Publication
(10) Pub. No.: US 2023/0241693 A1
(43) Pub. Date: Aug. 3, 2023

(54) AN ELECTRIC BROACHING PRESS OPERATING WITH AN ELECTRIC CYLINDER

(71) Applicant: Nikhil Ramesh Bhutada, Maharashtra (IN)

(72) Inventor: Nikhil Ramesh Bhutada, Maharashtra (IN)

(21) Appl. No.: 17/784,680

(22) PCT Filed: Aug. 20, 2021
(86) PCT No.: PCT/IN2021/050804

§ 371 Date: Jun. 13, 2022

(30) Foreign Application Priority Data
Dec. 23, 2020 (IN) 202021056087

(51) Int. Cl. B23D 37/10; B23D 41/08

(52) U.S. Cl. CPC B23D 37/10; B23D 41/08

(57) ABSTRACT

An electric broaching press 1 with electric cylinder 4 having a ball nut assembly with internal linear guide way support 5 is presented herewith. The ball nut assembly 5 is driven by electric motor 2 through set of pullies 4a. Rotational motion generated by the electric motor 2 is transmitted into linear motion by a ball screw and nut assembly 8. The ball screw and nut assembly 8 comprises a ball nut 8a, a ball nut housing 8b, and a ball screw 8c. The ball screw 8c transmits the rotational energy in to linear energy to a piston rod 12. The piston rod 12 causes vertical displacement and is attached to a cantilever support structure 20a holding broach tool to carry out broaching operation.

### FIELD OF THE INVENTION

The present disclosure generally relates to broaching press operation, and more particularly to an electric broaching press operating with an electric cylinder, where the electric cylinder is driven by an electric motor. The present disclosure particularly offers highly energy efficient broaching press as compared to conventional hydraulic broaching press machines which requires zero hydraulic oil consumption.

### TECHNICAL BACKGROUND

Broaching is a machining process that uses a toothed tool to remove material in a consistent and accurate way. The broaching machining process requires high pressure for pull and push movement of a broaching tool. Traditional broaching presses used for broaching machining are operated by hydraulic system. As it is well known in the art, the joined push stroke of the broaching tool and/ or tool holder, allows performing the operative cycle of internal and/ or external machining of the workpiece, while the separate displacement of the broaching tool permits clearing the access to the horizontal platform for introduction of the workpiece to be machined and removal of the machined workpiece.

Traditionally the vertical/ horizontal pull/ push broaching press of the aforementioned type are utilized for actuating the displacement of the broaching tool and/ or tool holder and a hydraulic actuator which requires a complex and huge hydraulic unit with associated auxiliary accessories, such as hoses, connectors, solenoid valve groups, and the like, are employed.

Hydraulic operation further involves problems connected to the control of the acceleration and deceleration paths as well as of the working speed of the broach or broaches, the constancy of which is also negatively affected by variations of the hydraulic fluid temperature.

Particular drawbacks of the hydraulic systems are as follow: In hydraulic system, electric energy is converted into rotational energy with the help of induction motor, this rotational energy is converted is converted into hydraulic energy and this hydraulic energy is then converted into linear broaching movement. This entire process of energy conversion causes loss of energy which is highly electric power consuming process. The operation of hydraulic system is messy and noisy. This hydraulic system requires heavy maintenance of hydraulic spares. Speed of the hydraulic broaching tool cannot be varied with respect to length of broach. Hydraulic system required additional cooling tower / oil chiller system. Hydraulic oil consumption is maj or issue for higher sizes of machines.

### BRIEF SUMMARY OF THE INVENTION

An object of the present disclosure is to provide an alternative broaching press with an electric cylinder to replace a conventional hydraulic system operated using hydraulic fluid, and a method to operate the alternative broaching press with the electric cylinder. The hydraulic fluid is subject to vary its performance based on temperature, contaminants which can cause changes in viscosity of the hydraulic fluid and reduce the hydraulic pressure. Therefore, it is object of the present disclosure to provide an electric broaching press that will not be subjected to temperature and contaminants as it does not include hydraulic oil.

The hydraulic system is high electric power consuming process. Therefore, it is an objective of the present disclosure to provide an electric broaching press that consumes lesser energy as compared to the conventional hydraulic system.

The hydraulic broaching machine is operated by converting electric energy to hydraulic energy. The operation of hydraulic fluid is messy and noisy. Therefore, it is an objective of the present disclosure to provide an electric broaching press that is clean and silent during operation as compared to the conventional hydraulic system.

The conventional hydraulic system requires heavy maintenance of hydraulic spare parts. Therefore, it is an objective of the present disclosure to provide a broaching press that requires minimum maintenance.

In conventional hydraulic system, a speed of hydraulic broaching operation cannot be varied with respect to length of broach. Therefore, it is an objective of the present disclosure to provide an electric broaching press with provision of controlling the speed of the broaching tool / tool holder with respect to length of broach as per the requirement.

The conventional hydraulic system required additional cooling chamber or oil cooldown system which adds up to machine cost and operational and maintenance expenses. Therefore, it is an objective of the present disclosure to provide an electric broaching press without requirement of such cooling chambers.

For conventional hydraulic system, oil consumption is major issue due to higher sizes of machines. Therefore, it is an objective of the present disclosure to provide an electric broaching press that requires no hydraulic oil consumption.

The present disclosure provides an electric broaching press with an electric cylinder having a ball nut assembly with internal linear guide way support, hereinafter referred as to ‘ball nut assembly’. According to one feature of a preferred embodiment, an electric broaching press mainly comprises a C-shaped framework, a cantilever support structure for Broaching tool and/or tool holder guided by external linear guide way support. In one aspect, the C-shaped framework, cantilever supported tool holder having two parallel horizontal platforms connected by a vertical pillar as a single structure. Two parallel horizontal platforms are referred as to a first horizontal platform and a second horizontal platform hereinafter. The first horizontal platform is disposed at upper portion of the C-shaped framework where an electric cylinder can be mounted. The second horizontal platform disposed at bottom portion of the framework for positioning a workpiece to be broached.

According to another feature of the preferred embodiment, the external linear guide way assembly is disposed at the vertical pillar of the framework to externally guide the broaching tool and /or tool holder. The cantilever support structure includes external linear guide way assembly moveably positioned to slide vertically with respect to the first horizontal platform and a second horizontal platform.

According to another feature of the preferred embodiment, the ball nut assembly is provided for precisely controlling vertical displacement of the ball nut. The ball nut assembly is enclosed within a cylindrical casing of an electric cylinder which is mounted on a top of the first horizontal platform of the framework. The electric cylinder is driven by an electric Motor. The electric cylinder comprises an electric motor, and a time drive belt, pullies / gear box assembly connected with ball screw. The electric motor can preferably be a servo / stepper motor, for rotational power generation. The rotational motion is imparted to the ball nut assembly in linear motion.

In accordance with one implementation of the preferred embodiment, the electric cylinder mainly comprises a ball nut assembly, vertically and about centrally secured within the cylindrical casing for converting rotational motion into linear motion to operationally move the cantilever support structure. The ball screw and nut assembly include a ball screw, a ball nut, and a ball nut housing. The ball screw is moveably retained at upper end of a ball nut and guided to cause vertical linear displacement of the ball nut by transmitting the linear energy to the piston rod, and wherein a piston rod end connector of the piston rod is detachably engaged to the cantilever support structure which holds broaching tool and / or tool holder in vertical linear direction to push the broaching tool downwardly towards the second horizontal platform of the framework with adequate force to cut through the workpiece and return to an original position.

The present disclosure discloses a method to operate an electric cylinder having a ball nut assembly, driven by an electric motor, to cause vertical displacement of a piston rod assembled with cantilever support holding broach tool. The method includes embedding a ball screw and nut assembly within the electric cylinder. The ball screw and nut assembly is placed vertically and about centrally secured within a cylindrical casing of the electric cylinder having the internal linear guide way support, for converting rotational motion induced by the electric motor into linear motion of piston rod assembled with cantilever support structure holding a broach tool.

The method further includes moveably retaining the ball screw at upper end of a ball nut and guiding the ball nut to cause vertical linear displacement of the piston rod by transmitting the linear energy to the piston rod. The method further includes pushing the broach tool downwardly towards the second horizontal platform of the framework through the linear displacement of the piston rod.

According to the present disclosure of the preferred embodiment is configured with the electric motor and a time drive assembly that combinedly form prime mover of the electric cylinder. The electric cylinder is configured to actuate the ball nut assembly that converts the rotational motion into linear motion through the ball screw. Use of the ball screw and nut assembly allows smooth and frictionless transmission of the motion. Use of the electric cylinder eliminates the need of hydraulic system, as required in conventional systems, and as a result, all the disadvantages associated with the hydraulic system are eliminated. Thus, the present embodiment offers clean, noise-free, less energy consuming system that does not require cooling chambers around, ultimately resulting in high speed and cost-effective broaching press.

### BRIEF DESCRIPTION OF THE DRAWING

The present disclosure will now be described with the help of accompanying drawing, in which:

FIG. 1 illustrates an electric cylinder, in accordance with preferred embodiment.

FIG. 2 illustrates a cross sectional view of a ball nut assembly of an electric cylinder, in accordance with the embodiment.

FIG. 2A illustrates 3D view of a linear guide way, in accordance with the embodiment.

FIG. 3 illustrates a schematic diagram of a vertical electric broaching press with the electric cylinder, in accordance with the embodiment.

FIG. 4 illustrates a schematic of cross-sectional view of an electric cylinder having internal linear guide way support, in accordance with the embodiment.

### DETAILED DESCRIPTION OF THE INVENTION

All the terms and expressions, which may be technical, scientific, or otherwise, as used in the present disclosure have the same meaning as understood by a person having ordinary skill in the art to which the present disclosure belongs, unless and otherwise explicitly specified.

In the present disclosure, and the claims, the articles “a”, “an”, and “the” include plural references unless the context clearly dictates otherwise.

The term “comprising” as used in the present disclosure and the claims will be understood to mean that the list following is non-exhaustive and may or may not include any other extra suitable features or elements or steps or constituents as applicable.

The present disclosure relates to an electric broaching press with an electric cylinder having internal linear guide way support, where electric cylinder is driven by electric motor and which overcomes one or more drawbacks associated with the prior art.

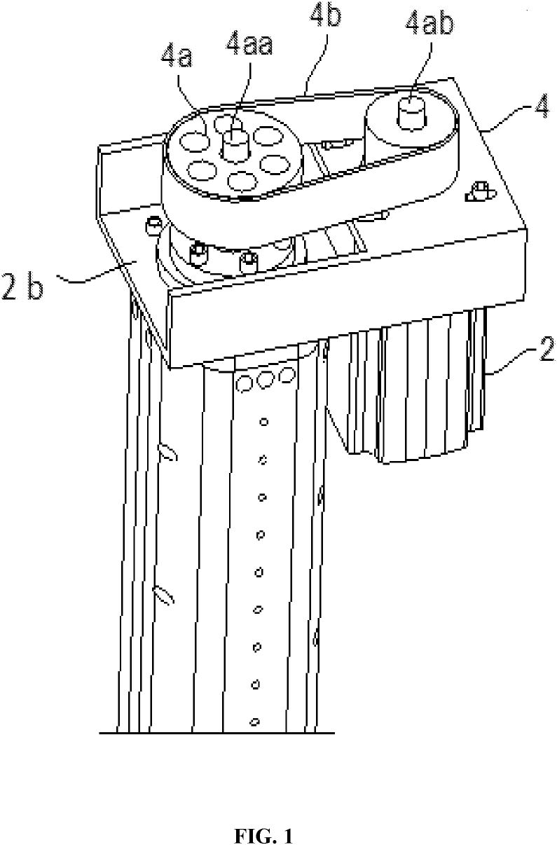

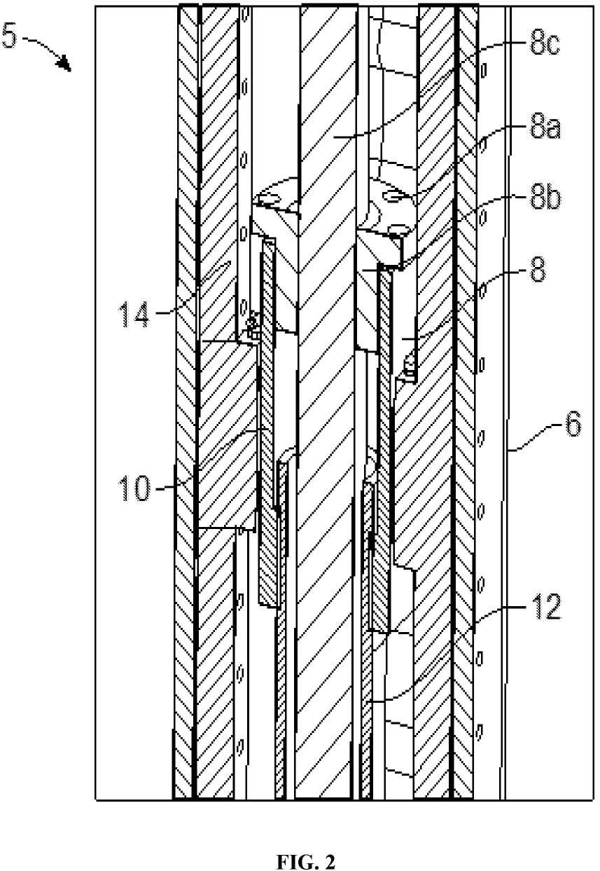

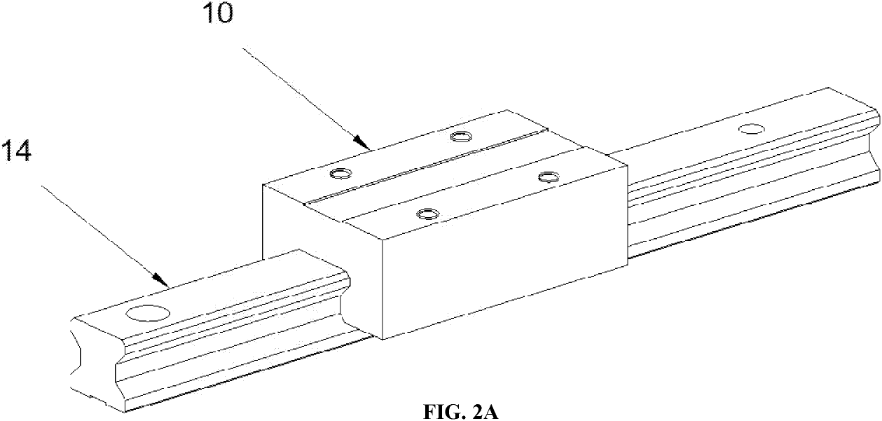

FIG. 1 illustrates an electric cylinder 4, in accordance with preferred embodiment. The electric cylinder 4 for actuating the broaching operation, is mounted on a first horizontal platform of a framework 16a. The electric cylinder 4 comprises an electric motor 2 and a time drive assembly. In one implementation of the embodiment, the electric motor 2 can be a brushless and/or servo motor. The electric motor 2 is conveniently of the servo motor type, which guarantees constant performance even at high speed, along with low operating noise, as well as high but constantly timely checked acceleration and deceleration. The time drive assembly is used for power transmission from the electric motor 2 to ball nut assembly 5 (FIG. 2) through ball screw 8c enclosed in electric cylinder 4. The time drive assembly includes a set of pulleys 4a, including a motor pulley 4ab, a ball screw pulley 4aa and a time drive belt 4b. Where a ratio of the timing belt and the set of pullies 4a is determined as per required speed and force for broaching machining process. In another implementation of the embodiment, power transmission techniques could be gears with clutches, direct drive, or chains could be employed in place of a belt drive.

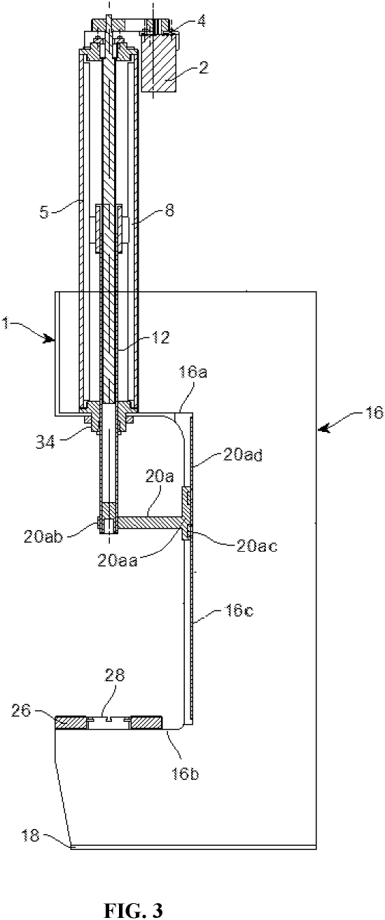

FIG. 2 illustrate a cross sectional view of a ball nut assembly 5, in accordance with the embodiment. The electric cylinder 4 having a ball nut assembly 5 has a linear guide way support and is driven by an electric motor 2 through set of pullies 4a as described with reference to FIG. 1. Rotational motion generated by the electric motor 2 is transmitted into linear motion by the ball screw and nut assembly 8 and is positioned at upper end of the framework that provides frictionless conversion of rotational motion into linear motion and operates a piston rod 12 to push a cantilever support structure 20a (shown in FIG. 3) which holds vertical broach tool / tool holder (not shown in fig.) to move from original position to downwards in vertical direction with adequate force to cut through a work piece to be broached. The ball nut assembly 5 mainly includes a ball screw and nut assembly 8, the piston rod 12, a linear guide way carriage 10 and a linear guide way rail 14 (as mentioned in FIG. 2A) enclosed in cylindrical body 6.

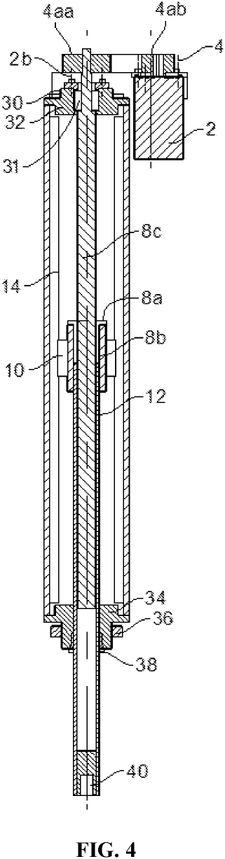

According to one implementation of the embodiment, the cylindrical body 6 is provided to encase the ball nut assembly 5. The ball screw and nut assembly 8, vertically and about centrally secured within the cylindrical casing, is provided to act as an electric cylinder 4 that translates rotational motion into linear motion with minimum friction. The ball screw and nut assembly 8 consists of a ball screw 8c and a ball nut 8a housed within a ball nut housing 8b (described in FIG. 4), each with matching helical grooves, and balls which roll between these grooves providing the only contact between the nut and the screw. As the screw or nut rotates, the balls are deflected by the deflector into the ball return system of the nut and the balls travel through a return system to the opposite end of the ball nut in a continuous path. The balls then exit from the ball return system into the ball screw 8c and nut thread raceways continuously to recirculate in a closed circuit. The ball screw and nut assembly 8 is attached to an upper end of the piston rod 12. Rotational motion is transmitted into a linear motion by the ball screw and nut assembly 8, and the linear motion is transmitted to the piston rod 12 to cause vertical displacement of a cantilever support structure 20a holding vertical broaching tool / tool holder (not shown in the figure).

FIG. 2A describes a linear guide way carriage 10 and a linear guide ways rail 14, according to one implementation of the preferred embodiment. The linear guides consist of a mechanism in which steel balls are circulated to enable a stroke of carriage 10 theoretically. Balls roll along the ball groove formed on a rail 14 and a carriage 10 to provide smooth and frictionless movement of carriage 10. The linear guide carriage 10 is attached to ball nut housing 8b to guide ball nut during its vertical displacement for vibration free movement. Rails 14 of linear guide way are attached to cylinder casing 6 internally on which the carriage 10 travels upward or downward.

FIG. 3 illustrates a schematic diagram of an electric broaching press 1 with electric cylinder 4 having ball nut assembly 5 is referred as to an electric broaching press 1 hereinafter. The electric broaching press 1 is installed on a machine foundation plate 18. The electric broaching press 1 has a framework 16 for fitting all machine components. The framework 16 is a C-shaped structure having two horizontal parallel platforms, referred as to a first horizontal platform 16a and a second horizontal platform 16b. The first horizontal platform 16a is formed at upper portion of the framework 16, whereas the second horizontal platform 16b is formed at bottom portion of the framework 16. The first and second horizontal platforms 16a, 16b are connected by a vertical pillar 16c.

According to one implementation, the Cantilever support structure 20a is mounted at the vertical pillar 16c of frame. The Cantilever support structure 20a includes a cantilever support end 20aa moveably positioned to slide vertically between the first horizontal platform 16a and a second horizontal platform 16b. The cantilever support structure 20a is a cantilever carrier beam having a first end 20aa moveably attached to the carriage 20ac of external linear guide way moving through linear guide rails 20ad and a second end 20ab attached to a piston rod 12 adapted to be pushed downwardly towards the second horizontal platform 16b cutting through the workpiece 28 to be broached clamped on fixture (not shown in fig.). The cantilever support structure 20a provides vertical alignment to the Piston rod 12 with respect to second horizontal platform 16b.

According to one implementation of the embodiment, the second horizontal platform 16b is mounted with a bolster plate 26 to hold a workpiece 28 and/ or workpiece holding fixture (not shown in fig) to be broached.

According to one implementation of the embodiment, the electric cylinder 4 is mounted on the first horizontal platform 16a. As described earlier, electric cylinder 4 includes ball nut assembly 5 actuated by the electric motor 2 through ball screw by means of time pully set 4a & belt 4b. The rotational motion is transmitted into linear motion through ball screw and nut assembly 8 to piston rod 12.

During operation cycle, the piston rod 12 is pushed and pulled back, causing downward and upward displacement of cantilever support structure 20a holding broach tool/ tool holder (not shown in fig.)

In one implementation of the preferred embodiment, the electric broaching press operation is controlled by CNC or PLC controller (not shown in the figure). CNC or PLC is applied to control speed of the electric cylinder 4 precisely. As a result, the speed of the broach tool / tool holder can be controlled or vary according to the requirement.

A method to operate the preferred embodiment is disclosed herein. The method is provided to operate the electric cylinder 4 having the ball nut assembly with internal linear guide way support 5, driven by an electric motor, to cause vertical displacement of a piston rod 12 assembled with cantilever support holding broach tool. The method includes embedding a ball screw and nut assembly 8 within the electric cylinder 4. The ball screw and nut assembly 8 is placed vertically and about centrally secured within a cylindrical casing of the electric cylinder 4 for converting rotational motion induced by the electric motor 2 into linear motion of piston rod 12 assembled with cantilever support structure holding a broach tool.

The method further includes moveably retaining the ball screw at upper end of a ball nut and guiding the ball nut to cause vertical linear displacement of the piston rod 12 by transmitting the linear energy to the piston rod 12. The method further includes pushing the broach tool downwardly towards the second horizontal platform of the framework through the linear displacement of the piston rod 12.

FIG. 4 illustrates a schematic of cross-sectional view of an electric cylinder 4 having ball nut assembly 5. The electric cylinder mainly includes a time drive assembly which further includes a set of pulleys 4a, including a motor pulley 4ab and a ball screw pulley 4aa with a time drive belt 4b. A ratio of the set of pullies 4a is determined as per required speed and force for broaching machining process. A motor mounting plate 2b is disposed at the upper portion of the electric cylinder. An electric motor 2 is attached to motor mounting plate 2b. The upper end of the ball screw 8c is connected to ball screw pulley 4aa which is hold by bearing sets 31 fixed in a bearing housing 32 and locked by Locking plate 30. Within the electric cylinder, ball nut assembly 5 is encased. The ball nut assembly 5 mainly includes a ball screw and nut assembly 8, the piston rod 12, a linear guide way carriage 10 and a linear guide way rail 14 (as mentioned in FIG. 2A). The ball screw and nut assembly 8 includes a ball nut 8a, a ball nut housing 8b, and a ball screw 8c. The ball screw and nut assembly 8 transmits the rotational motion generated by the electric motor 2 into linear motion of piston rod 12 which connected at lower end of ball nut housing 8b. The ball nut housing 8b is attached to carriage of internal linear guide way support 10 which slides on internal linear guide rails 14 to transmit vibration less motion. The linear motion generated by the ball screw and nut assembly 8 is then transmitted to the piston rod 12. Bottom flange 34 and a cylinder locking nut 36 is provided as a locking for the electric cylinder casing 6 on first horizontal platform 16a. The guide bush 38 is placed at lower end of bottom flange 34 to guide the piston rod 12. The piston rod end connector 40 is connected to a broach tool / tool holder to carry out broaching operation (not shown in the fig.).

The embodiments and implementation disclosed herein described the electric cylinder’s applicability in broaching press operation. However, implementation of the electric cylinder with internal linear guide way support is not limited to the broaching press. The electric cylinder with internal linear guide way support can be effective for multiplicity of other applications. The electric Cylinder with internal linear guide support can be used to replace hydraulic cylinder actuator system working at high force with high speeds required in various industrial applications, such as Industrial presses, moulding Machines, Factory automations, Packaging machines, Food processing machines, Pick and Place systems, Material handling equipment, and the like.

The present disclosure, by virtue of the preferred embodiment, presents an electric broaching press 1 operating with electric cylinder 4 having ball nut assembly 5, where electric cylinder 4 is driven by electric motor 2. This particular feature eliminates the requirement of hydraulic system and disadvantages associated with it. The electric cylinder 4 allows high and controllable speed operations that consume much lesser energy compared to conventional hydraulic systems. Use of ball screw and nut assembly 8 offers frictionless and noise free operation. The present disclosure thus results in super energy saving, effective and efficient electric broaching press 1.

The embodiments herein and the various features and advantageous details thereof have been explained with reference to the non-limiting embodiments.

The foregoing description of the specific embodiments have been described herein above that a person having ordinary skill in the art can apply the current knowledge, readily modify, or adapt for various applications such specific embodiments without departing from the generic concept. All such adaptations and modifications are intended to be comprehended within the meaning and range of equivalents of the disclosed embodiments.

Further, it is to be understood that the terminology employed herein is for the purpose of description and not of limitation. Therefore, while the embodiments herein have been described in terms of preferred embodiments, a person having ordinary skill in the art will readily recognize that the embodiments herein can be practiced with modification within the spirit and scope of the embodiments as described herein.

The use of the expression “at least” or “at least one” suggests the use of one or more elements or ingredients or quantities, as the use may be in the embodiment of the disclosure to achieve one or more of the desired objects or results.

Any discussion of documents, acts, materials, devices, articles, or the like that has been included in this specification is solely for the purpose of providing a context for the disclosure. It is not to be taken as an admission that any or all of these matters form a part of the prior art base or were common general knowledge in the field relevant to the disclosure as it existed anywhere before the priority date of this application.

The numerical values mentioned for the various physical parameters, dimensions or quantities are only approximations and it is envisaged that the values higher/lower than the numerical values assigned to the parameters, dimensions or quantities fall within the scope of the disclosure, unless there is a statement in the specification specific to the contrary.

While considerable emphasis has been placed herein on the components and component parts of the preferred embodiments, it will be appreciated that many embodiments can be made and that many changes can be made in the preferred embodiments without departing from the principles of the disclosure. These and other changes in the preferred embodiment as well as other embodiments of the disclosure will be apparent to those skilled in the art from the disclosure herein, whereby it is to be distinctly understood that the foregoing descriptive matter is to be interpreted merely as illustrative of the disclosure and not as a limitation.

1. An electric cylinder having a ball nut assembly with internal linear guide way support, driven by an electric motor, to cause vertical displacement of piston rod assembled with cantilever support holding broach tool, comprises:
a ball screw and nut assembly, vertically and about centrally secured within a cylindrical casing of the electric cylinder having the ball nut assembly, for converting rotational motion induced by the electric motor into linear motion of piston rod assembled with cantilever support structure holding broach tool, the ball screw and nut assembly comprises:
a ball nut,
a ball nut housing to fix a ball nut at predetermined positions;
wherein the ball screw is moveably retained at upper end of a ball nut and guided to cause vertical linear displacement of the ball nut by transmitting the linear energy to the piston rod, and wherein an end connector of the piston rod is detachably engaged to the cantilever support structure which holds broach tool in vertically linear direction to push the broach tool downwardly towards the second horizontal platform of the framework with adequate force to cut through the workpiece and return to an original position.

2. The electric cylinder as claimed in claim 1, wherein the electric cylinder can be deployed for multiplicity of applications where high force with high speeds is required, and wherein the multiplicity of applications comprises Industrial presses, moulding Machines, Factory automations, Packaging machines, Food processing machines, Pick and Place systems, Material handling equipment. Agriculture and Mining equipment.

3. An electric broaching press comprising:
a C shaped framework having a first horizontal platform disposed at upper portion of the framework where an electric cylinder can be mounted and a second horizontal platform disposed at bottom portion of the framework for positioning a workpiece to be broached, wherein the first horizontal platform and a second horizontal platform are parallel to each other;
an external linear guide way assembly disposed at a vertical pillar of C-frame structure moveably positioned to slide vertically with respect to the first horizontal platform and a second horizontal platform;
a ball nut assembly with internal linear guide way support for precisely controlling vertical displacement of a ball screw and nut assembly connected with a piston rod, wherein the ball nut assembly is enclosed within a cylindrical casing of electric cylinder which is mounted on a top of the first horizontal platform of the framework, wherein the electric cylinder having the ball nut assembly is driven by electric motor;
characterized in that the ball nut assembly, for converting rotational motion into linear motion to operationally guide the broach holding cantilever support structure, is provided with a ball nut housing to fix a ball nut at predetermined positions and a ball screw moveably retained at upper end of a ball nut and guided to cause vertical linear displacement of the ball nut, and wherein an end connector of the piston rod is detachably engaged to a cantilever supports structure holding a broach tool in vertically linear direction to push the broach tool downwardly towards the second horizontal platform of the framework with adequate force to cut through the workpiece and return to an original position.

4. The electric broaching press as claimed in claim 3, wherein rotational power can be transmitted using power transmission techniques including gears with clutches, direct drive, or chains.

5. The electric broaching press as claimed in claim 3, wherein ratio of a timing belt and a set of pullies is determined as per required speed and force for broaching machining process.

6. The electric broaching press as claimed in claim 3, wherein the speed of broaching machining process is controlled by at least one of CNC and PLC controller.

7. The electric broaching press as claimed in claim 3, wherein the moving and contact part of the electric broaching press is lubricated by means of pipes and lubrication pump.

8. The electric broaching press as claimed in claim 3, wherein the electric motor is of the brushless type and electronically controlled.

9. A method to operate an electric cylinder having a ball nut assembly, to cause vertical displacement of a piston rod assembled with cantilever support structure holding broach tool, the method comprises:
driving the electric cylinder by an electric motor;
embedding a ball screw and nut assembly within the electric cylinder, wherein the ball screw and nut assembly is placed vertically and about centrally secured within a cylindrical casing of the electric cylinder for converting rotational motion induced by the electric motor into linear motion of piston rod assembled with cantilever support structure holding a broach tool;
moveably retaining a ball screw at upper end of a ball nut and guiding the ball nut to cause vertical linear displacement of the piston rod by transmitting the linear energy to the piston rod; and
pushing the broach tool downwardly towards the second horizontal platform of the framework through the linear displacement of the piston rod.

10. The electric cylinder as claimed in claim 1, wherein the electric cylinder optionally comprises a lead screw a ACME threaded screw or a telescopic screw or alike screws instead of ball screw.
